(19) United States
(12) Patent Application Publication
(10) Pub. No.: US 2014/0005316 A1
(43) Pub. Date: Jan. 2, 2014

(54) Thermoplastic Composition

(71) Applicants: Dean Thetford, Norden (GB); Patrick J. Sunderland, Rossendale (GB)

(72) Inventors: Dean Thetford, Norden (GB); Patrick J. Sunderland, Rossendale (GB)

(73) Assignee: LUBRIZOL ADVANCED MATERIALS, INC., Wickliffe, OH (US)

(21) Appl. No.: 13/995,322

(22) PCT Filed: Dec. 19, 2011
(86) PCT No.: PCT/US11/65786

§ 371 Date: Sep. 12, 2013

Related U.S. Application Data
(60) Provisional application No. 61/425,284, filed on Dec. 21, 2010.

(51) Int. Cl. C08L 91/06

(52) U.S. Cl. CPC C08L 91/06
USPC 524/275

(57) ABSTRACT

The invention relates to a composition containing a particulate solid, a plastic material (such as a thermoplastic polymer) and a hydrogenated vegetable oil wax. The hydrogenated vegetable oil wax is capable of being a dispersant.

### FIELD OF INVENTION

The invention relates to a composition containing a particulate solid, a plastic material (such as a thermoplastic polymer) and a hydrogenated vegetable oil wax. The hydrogenated vegetable oil wax is capable of being a dispersant.

### BACKGROUND OF THE INVENTION

Thermoplastics such as PP, PE, etc., are typically coloured using pigment concentrates. The pigment concentrates are often referred to as masterbatches or compounds. These concentrates are prepared by mixing ingredients together and subjecting them to any of the processes commonly used for dispersing particulate solids in a thermoplastic polymer. Compounding or mixing in a twin-screw extruder is one of these processes. Pigment concentrations in masterbatches may contain up to 70% of pigment, and optionally other additives. Other additives may include waxes, dispersants, lubricants and UV stabilizers.

Production of masterbatches typically utilises a pigment dispersed in thermoplastic polymer, i.e., fine particles with limited amounts of aggregates. However, aggregates are known to form from the pigments in the production of masterbatches. The presence of aggregates tends to result in filter blocking of the extruder.

In addition, particular requirements are important for finished articles containing the thermoplastic polymer. The thermoplastic polymer may be in the form of a solid article, a film or fiber. In solid articles, acceptable dispersion of the pigment is necessary in order to maximise colour development, tinctorial strength and reduced speck levels. For films, incomplete dispersion of the pigment may lead to cracking, unwanted light scattering effects and specks. In fibres, incomplete dispersion of the pigment may result in fiber breakage.

U.S. Pat. No. 6,958,091 discloses pigments treated with at least one amide of a fatty acid and an aliphatic amine, providing improved processibility and dispersibility in thermoplastic materials, and improved properties to thermoplastic compositions containing said surface-treated pigments.

US Patent Application US 2002/0151639 discloses a composition comprising micronized polyolefins, polyolefin waxes or combinations thereof, wherein a proportion of the particle size fraction smaller than 10 μm of said composition is at least 1% by weight, a proportion of the particle size fraction smaller than 100 μm of said composition is at least 10% by weight, and a proportion of the particle size fraction smaller than 500 μm of said composition is at least 90% by-weight.

International Application WO 2006/049658 discloses an additive system for use in the fabrication of extruded wood-polymer composite articles, the additive system comprising a first lubricant selected from the group consisting of a salt of 12-hydroxystearic acid, an amide of 12-hydroxystearic acid, and combinations thereof. In addition, hydrogenated castor oil wax is disclosed as a lubricant to be used in combination with the first lubricant.

Japanese Application JP 04307232A discloses a composite of conductive filler in a resin of a damping steel plate. The composite contains one or more kinds of hydrogenated castor oil, fatty acid amide wax and polyethylene oxide.

U.S. Pat. No. 4,797,440 discloses the use of a polymer containing a carboxylate functionality, e.g., poly(12-hydroxystearic acid) or polyricinoleic acid, as a dispersant in the presence of a particulate solid, a lubricant and a thermoplastic polymer.

International Application WO 2009/091774 discloses 1-95% particulate solid (e.g., pigment), a plastic material (such as a thermoplastic polymer) and 0.1-50% compound containing an amide group. The compound is capable of being a dispersant. Plastic is 0-90% amorphous polyolefin, 0-90% wax, 0-30% crystalline polyolefin, or 0-75% hydrogenated castor oil wax.

British Patent GB 1342887 discloses an image transfer material for thermally transferring prints onto a substrate which consists of a support that is not specially pretreated and a printed image in an ink containing a thermoplastic resin and a wax. The wax may include hydrogenated castor oil.

U.S. Pat. No. 2,566,199 discloses casting compositions, characterized by sharp setting points, prepared from cellulose esters, hydrogenated castor oil, cellulose ester plasticizers, and low molecular polymers.

Japanese Patent Application JP 2003119395A disclose a composition that contains thermoplastic resins 100 parts, tackifiers 10-150 parts and an amide wax having m.p. of 110-160° C. or/and hydrogenated castor oil-modified amide wax (as thixotropic agent), 0.2-5 parts.

Japanese Patent Application 2005168586A discloses a gel that contains hydrogenated fatty acid triglycerides, volatile hydrocarbons, thermoplastic elastomers, and optionally perfumes, deodorants, or insecticides. Hydrogenated castor oil is also disclosed as being added.

### SUMMARY OF THE INVENTION

The composition, described herein, is able to minimise at least one of any of the technical challenges discussed above. These challenges may lead to less efficient processing in expensive extruder-type equipment, causing production costs to increase. The present invention therefore identifies compounds and compositions thereof capable of dispersing a pigment allowing a thermoplastic to have at least one of (i) a reduction in aggregates and specks, (ii) provides a finer state of dispersion (for example having a lower filter pressure value), (iii) has acceptable tinctorial strength and has improved brightness, and (iv) faster rates of dispersion.

In one embodiment, the invention provides a masterbatch composition comprising, a solid plastic material, greater than 0.1 wt. % to less than 20 wt. % of a hydrogenated vegetable oil wax, and a solid particulate, wherein the solid particulate is a pigment or filler. Typically, the composition of the invention is not a gel.

The hydrogenated vegetable oil wax may be present at 0.2 wt. % to 18 wt. %, or 1 wt. % to 15 wt. %, or 2 wt. % to 15 wt. %, or 5 wt. % to 15 wt. % of the masterbatch composition.

The masterbatch composition may be letdown (may also be referred to as diluted) to a lower concentration by addition to a further amount of plastic material. The masterbatch may be letdown to as low as a four hundredth of the mastermatch concentration. The composition may be suitable for manufacture of a film, a fibre or a solid article.

In a formulation of a solid article, the masterbatch composition may be diluted such that the hydrogenated vegetable oil wax is present in an amount ranging from 0.005 to 0.5 wt. %, or 0.01 to 0.25 wt. %, or 0.01 to 0.15 wt. % of the composition of solid article.

In one embodiment, the invention provides for the use of the hydrogenated vegetable oil wax, defined above, as a dispersant in a composition disclosed herein (i.e., coloured masterbatch or concentrate or solid article).

### DETAILED DESCRIPTION OF THE INVENTION

The present invention provides a composition and use as disclosed herein above.

### Hydrogenated Vegetable Oil Wax

The hydrogenated vegetable oil wax may be chemically modified, or un-modified. A chemically modified hydrogenated vegetable oil wax may contain amide functionality, imide functionality, whole or partial salts (typically of an ammonium counterion or metal such as alkali or alkaline earth metals). In one embodiment, the hydrogenated vegetable oil wax may not be amide-functionalised. Typically, the hydrogenated vegetable oil wax may be un-modified.

The hydrogenated vegetable oil wax may be a vegetable derived wax, or mixtures thereof. The hydrogenated vegetable oil wax may be solid at room temperature and melts at 50° C. or higher. The melting point may be 50° C. to 80° C. The hydrogenated vegetable oil wax may have an iodine number of up to 7 or less than 7. The hydrogenated vegetable oil wax may contain triglycerides of fatty acids.

The hydrogenated vegetable oil wax may be a derived wax that may include arrayan wax, carnauba wax, sugar cane wax, candelilla wax or hydrogenated castor oil. The hydrogenated vegetable oil wax may be a derived wax that may include candelilla wax or hydrogenated castor oil. In one embodiment, the hydrogenated vegetable oil wax may be hydrogenated castor oil wax, or mixtures thereof.

The hydrogenated vegetable oil wax may be employed alone as a dispersant in the composition disclosed herein.

The hydrogenated vegetable oil wax may be employed as a dispersant in a mixture with at least one additional dispersant known in the field of solid plastic material.

### INDUSTRIAL APPLICATION

In one embodiment, the hydrogenated vegetable oil wax, as described herein, is a processing aid or dispersant.

The particulate solid present in the composition may be any inorganic or organic solid material.

The solid particulate may be an organic pigment, an inorganic pigment, an organic filler, an inorganic filler, a flame retardant, or mixtures thereof.

The solid particulate may be an inorganic pigment, an inorganic filler, a flame retardant, or mixtures thereof. In one embodiment, the particulate solid is a pigment.

The solid particulate may be an organic pigment, an organic filler, or mixtures thereof.

In one embodiment, the particulate solid is an organic pigment from any of the recognised classes of pigments described, for example, in the Third Edition of the Colour Index (1971) and subsequent revisions of, and supplements thereto, under the chapter headed “Pigments”.

Examples of organic pigments are those from the azo, disazo, trisazo, condensed azo, azo lakes, naphthol pigments, anthrapyrimidine, benzimidazolone, carbazole, diketopyrrolopyrrole, flavanthrone, indigoid pigments, isoindolinone, isoindoline, isoviolanthrone, metal complex pigments, oxazine, perylene, perinone, pyranthrone, pyrazoloquinazolone, quinophthalone, triarylcarbonium pigments, triphendioxazine, xanthene, thioindigo, indanthrone, isoindanthrone, anthanthrone, anthraquinone, isodibenzanthrone, triphendioxazine, quinacridone and phthalocyanine series, especially copper phthalocyanine and its nuclear halogenated derivatives, and also lakes of acid, basic and mordant dyes, and carbon black. Carbon black, although strictly inorganic, behaves more like an organic pigment in its dispersing properties. In one embodiment, the organic pigments are phthalocyanines, especially copper phthalocyanines, monoazos, disazos, indanthrones, anthranthrones, quinacridones, diketopyrrolopyrroles, perylenes and carbon black.

Inorganic solids include: extenders and fillers such as talc, kaolin, montmorillonites including bentonites, hectorites and saponites, mica, silica, barytes and chalk, flame-retardant fillers such as alumina trihydrate, natural magnesium hydroxide; or brucite, particulate ceramic materials such as alumina, silica, zirconia, titania, silicon nitride, boron nitride, silicon carbide, boron carbide, mixed silicon-aluminium nitrides and metal titanates; particulate magnetic materials such as the magnetic oxides of transition metals, especially iron and chromium, e.g., gamma-Fe₂O₃, Fe₃O₄, and cobalt-doped iron oxides, calcium oxide, ferrites, especially barium ferrites; and metal particles, especially metallic iron, nickel, cobalt, copper and alloys thereof. Flame retardants may also include pentabromodiphenyl ether, octabromodiphenyl ether, decabromodiphenyl ether, hexabromocyclododecane, ammonium polyphosphate, melamine, melamine cyanurate, antimony oxide and borates; biocides or industrial microbial agents such as those mentioned in tables 2, 3, 4, 5, 6, 7, 8 and 9 of the chapter entitled “Industrial Microbial Agents” in Kirk-Othmer's Encyclopedia of Chemical Technology, Volume 13, 1981, 3^{rd} Edition.

Examples of other inorganic pigments include metallic oxides such as titanium dioxide, rutile titanium dioxide and surface coated titanium dioxide, titanium oxides of different colours such as yellow and black, iron oxides of different colours such as yellow, red, brown and black, zinc oxide, zirconium oxides, aluminium oxide, oxymetallic compounds such as bismuth vanadate, cobalt aluminate, cobalt stannate, cobalt zincate, zinc chromate and mixed metal oxides of manganese, nickel, titanium, chromium, antimony, magnesium, cobalt, iron and aluminium, Prussian blue, vermillion, ultramarine, zinc phosphate, zinc sulphide, molybdates and chromates of calcium and zinc, metal effect pigments such as aluminium flake, copper, and copper/zinc alloy, pearlescent flake such as lead carbonate and bismuth oxychloride.

The solid plastic material may be a thermoplastic resin, or mixtures thereof. The thermoplastic resin may be a homopolymer, or a copolymer. In one embodiment, thermoplastic resin includes polyolefins (homopolymers or copolymers), polyesters, polyamides, polycarbonates, polyurethanes, polystyrenics, poly(meth)acrylates, celluloses and cellulose derivatives. Said compositions may be prepared in a number of ways but melt mixing and dry solid blending are typical methods.

Examples of a suitable thermoplastics include (low density, or linear low density or high density) polyethylene, polypropylene, polystyrene, high impact polystyrene (HIPS), styrene acrylonitrile styrene (SANS), polyethylene terephthalate (PET), polybutylene terephthalate (PBT), nylon 6, nylon 6-6, nylon 6-12, nylon 11, nylon 12, nylon 4-6, polymethylmethacrylate, polyethersulphone, polysulphone, polycarbonate, polyvinyl chloride (PVC), chlorinated polyvinyl chloride, thermoplastic polyurethane, ethylene vinyl acetate (EVA), Victrex PEEK™ polymers (such as oxy-1,4-phenyleneoxy-1,4-phenylene-carbonyl-1,4-phenylene polymers) and acrylonitrile butadiene styrene polymers (ABS); and various other polymeric blends or alloys.

The compositions, typically, contain from 1 to 95% by weight of the particulate solid, the quantity depending on the nature of the solid and the relative densities of the solid and the plastic material. For example, a composition in which the solid is an organic material, such as an organic pigment, in one embodiment contains from 15 to 60% by weight of the solid whereas a composition in which the solid is an inorganic material, such as an inorganic pigment, filler or extender, in one embodiment contains from 40 to 90% by weight of the solid based on the total weight of composition.

The composition may include other ingredients such as antifogging agents, nucleators, blowing agents, flame retardants, process aids, surfactants, heat stabilizers, UV absorbers, fragrances, anti-microbial agents, biocides, impact modifiers, antioxidants, antistatic agents, coupling agents, foaming agents, mould-release agents, lubricants (external and internal), plasticisers, slip agents, UV stabilisers, viscosity depressants, dispersants other than the hydrogenated vegetable oil wax of the present invention, and air-release agents.

The composition may be prepared by any of the conventional methods known for preparing thermoplastic compounds. Thus, the solid, the thermoplastic polymer, and the dispersant may be mixed in any order, the mixture then being subjected to a mechanical treatment to reduce the particles of the solid to an appropriate size, for example, by Banbury mixing, ribbon blending, twin-screw extrusion, twin-roll milling, compounding in a Buss co-kneader, or similar equipment.

In one embodiment, the composition of the invention further includes one or more additional known dispersants.

In one embodiment, the invention provides for a micronised composition as is described herein. In one embodiment, the particle size (volume average) fraction may be 50 nm to 1 mm diameter, or 100 nm to 0.5 mm.

Another use of the hydrogenated vegetable oil wax of the present invention is in the production of dispersible solids in powder particle and/or fibre particle form, particularly of dispersible pigments or polymeric fillers, where the particles are coated with the dispersant. Coatings of this kind, of both organic and inorganic solids, are carried out in a known way, as described for example in EP-A-0 270 126. In this case, a solvent or emulsion medium may either be removed or remain in the mixture, forming pastes. These pastes are customary commercial products and may further comprise binder fractions and also further auxiliaries and additives. In the case of pigments, it is possible to coat the pigment surface during or after the synthesis of the pigments, by, for example, adding the hydrogenated vegetable oil wax of the invention to the pigment suspension, or during or after the operation of pigment finishing. The pigments pretreated in this way are notable for greater ease of incorporation and also for enhanced viscosity, flocculation and gloss performance and for higher colour strength, as compared with untreated pigments.

The composition comprising the hydrogenated vegetable oil wax and the plastic material may be formulated with the particulate solid in a similar manner to that described hereinbefore for the hydrogenated vegetable oil wax, and the plastic material. This composition may then be treated as a “master batch” and added to additional polymeric material when forming fabricated articles. The amount of “master batch” which is mixed with the additional polymeric material may vary over wide limits depending on the nature of polymeric material and the particulate solid. In different embodiments, the amount of “master batch” ranges include 0.1 to 50%, or 0.5 to 20%, or 1 to 5% based on the total weight of the final plastic article (typically thermoplastic). Although the plastic material used in preparing the “master batch” may differ from the addition of further plastic material, but typically it may be the same. The use of “master batches” is especially useful where the plastic material include polystyrene, high impact polystyrene (HIPS), styrene acrylonitrile styrene (SANS), polypropylene, polyethylene, polyethylene/polypropylene diene, ethyl vinyl acetate, polychloroprene, chlorinated polyethylene, chloro sulphonated polyethylene, poly(vinyl chloride), natural and synthetic rubber such as butadiene-based elastomers (for instance, butadiene-styrene, butadiene-acrylonitrile rubbers, polybutadiene), polyisoprene or natural rubber.

The following examples provide illustrations of the invention. These examples are non exhaustive and are not intended to limit the scope of the invention.

### Examples

A series of thermoplastic compositions are prepared from high density polyethylene (HDPE). Comparative Example 1 (CE1) is a thermoplastic composition that contains no dispersant. Comparative Example 2 (CE2) is a polyethylene wax AC-16a commercially available from Honeywell, at 12 wt. % loading. Inventive Example 1 (IE1) contains hydrogenated castor oil wax at 12 wt. % loading.

Dispersant Evaluation Test 1: 60 parts of each agent are charged into a Henschel mixer with Heuco Green 600703K (Pigment Green 7, 200 parts) and LDPE pellets (Exxon Mobil LD600 240 parts). The materials are blended together for 60 seconds to form a premix. This premix is compounded through a Thermo Prism TSE16TC twin screw extruder, with a screen pack profile of 400/60 mesh. The temperature profile for the extruder zones is 60/130/140/160/160 from feeder to die. The pressure in bar behind the screen pack is recorded digitally. The pressure data, taken at 100 second intervals, is presented in the table below. The letters OP in the table indicate that the pressure behind the screen pack is greater than 100 bar, the over-pressure limit of the extruder. The results obtained are:

| | Filter Pack Pressure in Bar | | | | | | | | | |
|---|---|---|---|---|---|---|---|---|---|---|
| Example | 100 s | 200 s | 300 s | 400 s | 500 s | 600 s | 700 s | 800 s | 900 s | 1000 s |
| CE1 | 82 | 92 | OP | OP | OP | OP | OP | OP | OP | OP |
| CE2 | 32 | 43 | 49 | 59 | 68 | 83 | OP | OP | OP | OP |
| IE1 | 7 | 10 | 12 | 14 | 17 | 22 | 26 | 30 | 38 | 40 |

Footnote to Table:
OP indicates over pressure limit reached
s is the number of seconds.

Dispersant Evaluation Test 2: The melt is prepared in a similar way as shown in Test 1. Then the coloured masterbatch (2 parts) is letdown with a white masterbatch (13.33 parts) (Plaswite PE7024 ex Cabot) containing 60% titanium dioxide and more letdown HDPE polymer (384.67 parts) (ex Borealis MG9641) using a Betol single screw extruder. The extruded pellets were collected and then injection moulded on a Boy 15S Injection Moulder into 50×35 mm plaques. The changes in colour strength of the plaques for each example versus the control are measured using the Spectroflash 600 spectrophotometer. The results obtained are:

| | Treat Rate (wt %) | Colour Strength (%) |
|---|---|---|
| CE1 | 0 | 100 |
| CE2 | 12 | 106.96 |
| IE1 | 12 | 123.45 |

Dispersant Evaluation Test 3: 84 parts of each agent are charged into a Henschel mixer with Irgalite Rubine 4BP (Pigment Red 57.1, 210 parts, ex BASF) and LLDPE pellets (Dowlex 2631 406 parts, ex Dow). The control contained 490 g of LLDPE powder and no dispersant. The agent IE1 was also tested at reduced dosage (56 parts), the weight of the formulation being made up by increasing the amount of LLDPE used (434 parts). The materials are blended together for 60 seconds to form a premix. This premix is compounded through a Thermo Prism TSE16TC twin screw extruder, with a screen pack profile of 400/60 mesh. The temperature profile for the extruder zones is 80/160/170/200/180 from feeder to die. Then the coloured masterbatch (16.67 parts) is letdown into LDPE polymer (183.33 parts) (ex Exxon LD600BA) using a Brabender Filtratest Unit with a temperature profile for the extruder zones of 180/190/200/200/200 from feeder to die and a melt volume throughput of 50 cm³/min. The filter pressure value, defined as the increase of pressure/gram of colourant, was calculated from the measurements taken according to the method described in DIN EN 13900-5.

| | Masterbatch Treat | Filter Pressure Value |
|---|---|---|
| | Rate (wt %) | (bar/g) |
| CE1 | 0 | 38.2 |
| CE2 | 12 | 29.9 |
| IE1 | 12 | 1.7 |

Dispersant Evaluation Test 4: The masterbatch is prepared in a similar way, as shown in Test 3. Then the coloured masterbatch (0.67 parts) is letdown with a white masterbatch (3.33 parts) (Plaswite PE7024 ex Cabot) containing 60% titanium dioxide and more letdown LDPE polymer (96 parts) (ex Exxon LD605BA) using a Betol single screw extruder. The extruded pellets were collected and then injection moulded on a Boy 15S Injection Moulder into 50×35 mm plaques. The changes in colour strength of the plaques for each example versus the control are measured using the Spectroflash 600 spectrophotometer. The results obtained are:

| | Masterbatch Treat | |
|---|---|---|
| | Rate (wt %) | Colour Strength (%) |
| CE1 | 0 | 100 |
| CE2 | 12 | 244.79 |
| IE1 | 12 | 312.66 |

Dispersant Evaluation Test 5: 84 parts of each agent are charged into a Henschel mixer with Irgalite Rubine 4BP (Pigment Red 57.1 210 parts, ex BASF) and PP powder (Elftex HV 001 PF 406 parts, ex Solvay). The control contained 490 g of LLDPE powder and no dispersant. The materials are blended together for 60 seconds to form a premix. This premix is compounded through a Thermo Prism TSE16TC twin screw extruder, with a screen pack profile of 400/60 mesh. The temperature profile for the extruder zones is 170/190/210/220/220 from feeder to die. Then the coloured masterbatch (3.33 parts) is letdown into PP polymer (196.67 parts) (ex Total Petrochemical PPH 5060) using a Brabender Filtratest Unit with a temperature profile for the extruder zones of 180/200/220/220/230 from feeder to die and a melt volume throughput of 50 cm³/min. The filter pressure value, defined as the increase of pressure/gram of colourant, was calculated from the measurements taken according to the method described in DIN EN 13900-5.

| | Masterbatch Treat | Filter Pressure Value |
|---|---|---|
| | Rate (wt %) | (bar/g) |
| CE1 | 0 | 199.2 |
| CE2 | 12 | 187.3 |
| IE1 | 12 | 30.5 |
| IE1 | 8 | 186.9 |

Dispersant Evaluation Test 6: The masterbatch is prepared in a similar way, as shown in Test 5. Then the coloured masterbatch (0.67 parts) is letdown with a white masterbatch (3.33 parts) (Plaswite PE7024 ex Cabot) containing 60% titanium dioxide and more letdown PP polymer (96 parts) (ex Total Petrochemical PPH 5060) using a Betol single screw extruder. The extruded pellets were collected and then injection moulded on a Boy 15S Injection Moulder into 50×35 mm plaques. The changes in colour strength of the plaques for each example versus the control are measured using the Spectroflash 600 spectrophotometer. The results obtained are:

| | Masterbatch Treat | |
|---|---|---|
| | Rate (wt %) | Colour Strength (%) |
| CE1 | 0 | 100 |
| CE2 | 12 | 208.28 |
| IE1 | 12 | 324.61 |
| IE1 | 8 | 242.43 |

Overall, the data obtained from the tests indicates that the compositions of the invention have acceptable performance after more than one thousand seconds. Accordingly, the composition of the present invention is capable of dispersing a pigment that also allows for a thermoplastic to have at least one of a reduction in aggregates and specks, provides a finer state of dispersion (for example, having a lower filter pressure value), has acceptable tinctorial strength, and has acceptable brightness and faster rates of dispersion.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition, referred to herein, should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits, set forth herein, may be independently combined. Similarly, the ranges and amounts for each element of the invention may be used together with ranges or amounts for any of the other elements.

While the invention has been explained in relation to its preferred embodiments, it is to be understood that various modifications thereof will become apparent to those skilled in the art upon reading the specification. Therefore, it is to be understood that the invention, disclosed herein, is intended to cover such modifications as fall within the scope of the appended claims.

What is claimed is:

1.-12. (canceled)

13. A masterbatch composition comprising, a solid plastic material, greater than 0.1 wt. % to less than 20 wt. % of a hydrogenated vegetable oil wax, and a solid particulate, wherein the solid particulate is a pigment or filler, wherein the solid plastic material is a thermoplastic resin, and wherein the thermoplastic is low density, or linear low density or high density polyethylene, or polypropylene.

14. The masterbatch composition of claim 13, wherein the hydrogenated vegetable oil wax is a hydrogenated castor oil wax.

15. The masterbatch composition of claim 13, wherein the hydrogenated vegetable oil wax is present at 0.2 wt. % to 18 wt. % of the masterbatch composition.

16. The masterbatch composition of claim 13, wherein the hydrogenated vegetable oil wax is present at 1 wt. % to 15 wt. %, of the masterbatch composition.

17. The masterbatch composition of claim 13, wherein the hydrogenated vegetable oil wax is present at 2 wt. % to 15 wt. % of the composition.

18. The masterbatch composition of claim 13, wherein the hydrogenated vegetable oil wax is present at 5 wt. % to 15 wt. % of the composition.

19. The masterbatch composition of claim 13, wherein the hydrogenated vegetable oil wax is not chemically modified beyond hydrogenation.

20. The masterbatch composition of claim 13, wherein the hydrogenated vegetable oil wax is not amide-functionalised.

21. The masterbatch composition of claim 13, wherein the solid particulate is an organic pigment, an inorganic pigment, an organic filler, an inorganic filler, a flame retardant, or mixtures thereof.

22. The masterbatch composition of claim 13, wherein the solid particulate is an inorganic pigment, an inorganic filler, a flame retardant, or mixtures thereof.

23. The masterbatch composition of claim 13, wherein the solid particulate is an organic pigment, an organic filler, or mixtures thereof.

24. The masterbatch composition of claim 13, wherein the particulate solid is a pigment.
